(19) United States
(12) Patent Application Publication
(10) Pub. No.: US 2024/0193561 A1
(43) Pub. Date: Jun. 13, 2024

(54) SYSTEMS AND METHODS FOR AN AUTHENTICATION LOG-IN INTERRUPT PROCESS

(71) Applicant: Wells Fargo Bank, N.A., San Francisco, CA (US)

(72) Inventors: Ashish B. Kurani, Hillsborough, CA (US); Sotirios K. Barkas, San Jose, CA (US); Ha Duong, San Francisco, CA (US); Margot Lockwood-Stein, Palo Alto, CA (US)

(21) Appl. No.: 18/587,307

(22) Filed: Feb. 26, 2024

Related U.S. Application Data
(63) Continuation of application No. 15/295,137, filed on Oct. 17, 2016, now abandoned.

(51) Int. Cl. G06Q 20/10; G06Q 20/40; G06Q 40/02

(52) U.S. Cl. CPC G06Q 20/102; G06Q 20/40; G06Q 40/02

(57) ABSTRACT

Systems and methods for detecting, capturing, and adjusting a user account's limit are provided herein. A method includes pulling information of a user, determining a financial health of the user based on the pulled information, placing the user into an initial tier of a finite number of tiers based on the financial health of the user, determining a limit for the user based on the initial tier placement of the user, adjusting the limit for the user based on a funds transfer request, rejecting the funds transfer request based on the adjusted limit, generating an authentication request with a failed transaction message, and rendering the authentication request as a splash page on a mobile device of the user when the user accesses a website associated with the financial institution.

### CROSS-REFERENCE TO RELATED PATENT APPLICATION

This application is a continuation of U.S. patent application Ser. No. 15/295,137, filed Oct. 17, 2016, which is incorporated herein by reference in its entirety and for all purposes.

### TECHNICAL FIELD

Embodiments of the present disclosure relate to systems and methods for facilitating payment transactions.

### BACKGROUND

Individuals often have one or more financial accounts that enable them to, among other functions, provide payment to other individuals or entities. For example, an individual may have an account at a financial institution that allows them to pay bills, transfer funds, and the like. These various payments can use any number of payment channels or rails to effectuate the payment. These payment channels or rails (henceforth collectively referred to as “payment channels”) may include, but are not limited to, any of the Automated Clearing House (“ACH”), a wire transfer rail, real-time payment system rail, a credit card processing rail, and the like. However, these payment channels may be cumbersome and difficult to use. Further, such payment channels are typically unbeknownst to the user.

### SUMMARY

A dynamic limit circuit that is a cross-channel, cross-service, and cross-instrument is described and provided herein. The dynamic limit circuit is configured to examine the totality of the relationship between a financial institution and a user (e.g., account holder, individual, customer, etc.) and, based off of a plurality of inputs and factors, as well as the details of a requested transaction, the dynamic limit circuit may authorize or deny a specific requested transaction by a user.

A first example embodiment relates to a method of managing a dynamic limit circuit for a user across at least some of their digital payment services. The method includes identifying a payment channel associated with a payment device of a user. Information is extracted regarding the user that is indicative of a financial health of the user based on the identification of the payment channel and the associated payment device of the user. The user is placed into a tier based on the financial health of the user. A limit is dynamically adjusted for the user based on a funds transfer request through the payment device, wherein the limit is responsive to at least the funds transfer request and the tier.

Another embodiment relates to a system for managing a dynamic limit circuit by a computing system of a financial institution. The system includes an accounts database structured to store information regarding a user, wherein the information is indicative of a financial health of the user. The system further includes a dynamic limit circuit communicably and operatively coupled to the accounts database. The dynamic limit circuit structured to identify a payment channel associated with a payment device of a user. Based on the identification of the user, information is extracted from the accounts database regarding the user that is indicative of a financial health of the user. The user is placed into a tier based on the financial health of the user. A limit is dynamically adjusted for the user based on a funds transfer request through the payment device, wherein the limit is responsive to at least the funds transfer request and the tier.

Another embodiment relates to a method of managing a dynamic limit circuit for a user across at least some of their digital payment services. The method includes identifying a payment channel associated with a payment device of a user. Based on the identification of the user, information is extracted regarding the user that is indicative of a financial health of the user. The user is placed into a tier based on the financial health of the user. A funds transfer request is received through the payment device of the user. A limit is dynamically adjusted for the user based on a funds transfer request through the payment device, wherein the limit is responsive to at least the funds transfer request and the tier. The funds transfer request is selectively approved for the user based on the dynamically adjusted transaction limit.

These and other features, together with the organization and manner of operation thereof, will become apparent from the following detailed description when taken in conjunction with the accompanying drawings.

### BRIEF DESCRIPTION OF THE FIGURES

FIG. 1 is a schematic diagram of a funds transfer system, according to an example embodiment.

FIG. 2 is a schematic diagram of the dynamic limit circuit of FIG. 1, according to an example embodiment.

FIG. 3 is a flow diagram of providing a dynamic limit for a transaction, according to an example embodiment.

FIG. 4 is a flow diagram of a method of selectively approving or denying a requested transaction, according to an example embodiment.

FIG. 5 illustrates a display screen or graphical user interface that may be displayed to the user during the process of FIG. 2 or FIG. 4, according to an example embodiment.

### DETAILED DESCRIPTION

Current payment channel ecosystems are problematic and cumbersome to use. For example, conventional systems usually require that each individual payment channel has a transaction limit. Further, there is no sharing of information or communication between the different payment channels. Therefore, a single user may have multiple payment channel limits (e.g., a high limit for a frequently used payment channel, but a relatively low limit for a less frequently used payment channel). The system and methods described herein enable aggregating these payment channel limits to effectuate a dynamic spending limit useable with all or mostly all of the payment channels of a user.

Referring to the Figures generally, the systems and methods described herein relate to receiving a funds transfer request, dynamically calculating or determining a funds transfer limit for a payment channel based on the request, and causing a processor to approve or deny the request based on the calculated dynamic limit to, in turn, selectively effectuate the funds transfer. In one embodiment, the systems and methods described herein may be implemented by a financial institution computing system associated with a financial institution. The financial institution computing system may have a dynamic limit circuit configured to dynamically adjust the limit for the user and, ultimately, approve or deny a requested transaction. In other embodiments, the dynamic limit circuit is a separate computing system or entity relative to the financial institution, whereby the dynamic limit computing system receives the transaction request from the financial institution, dynamically adjusts the limit for the user, and transmits a transaction approval or denial value to selectively authorize or deny the requested fund transfer. In this embodiment, the dynamic limit circuit may be located, either in part or as a whole, on a user device (e.g., smartphone) configured to perform all or most of the processes described herein with respect to the dynamic limit circuit. In either embodiment, the dynamic limit circuit calculates, establishes, or otherwise determines a new funds transfer limit for a particular payment channel each time a transaction or transfer occurs, and notifies the user (or, facilitates notification via the financial institution to the user) of an approaching limit for one or more of the payment channels.

The dynamic limit circuit allows the financial institution to improve the user's experience by dynamically tailoring, adjusting, and controlling a limit responsive to the individual user (e.g., financial health of the individual, available funds, transaction history, credit score, etc.). Consequently, the dynamic limit circuit may alleviate the problem of having a potential transaction denied while using a specific payment channel. As will be appreciated, the dynamic limit circuit determines a limit responsive to a plurality of inputs and a funds transfer request, the limit may be a payment channel limit, a spending limit, a transaction specific limit, or any combination of the three. For example, a user may have a frequently used debit card and an infrequently used credit card, both issued through the same financial institution, with both cards having different payment channels. The user's credit card may have a 500 U.S. dollars (“U.S.D.”) transaction limit due to low usage and the debit card may have a 2000 U.S.D. transaction limit due to funds in the account of the user and a robust transaction history. If the user were to use the credit card to make a 1200 U.S.D. purchase at a merchant, the dynamic limit circuit may receive the request, examine a payment channel limit tied to the credit card, examine a payment channel for the debit card and other services, examine a previously determined tier for the user, dynamically adjust the payment channel for the credit card, and selectively approve the transaction. In this regard, the dynamic limit circuit controls the transaction limit to determine a more accurate and robust dynamic “limit” to effectuate the transaction request. Therefore, in use, the dynamic limit circuit can change a transaction limit for a payment card per transaction, or change a spending limit for the payment card month to month.

As mentioned above, the dynamic limit circuit may be structured to determine a tier for a user of a financial institution. As used herein, the term “tier” refers to the level, categorization, or other classification of the user based on financial information regarding the user, such as the user's financial health (defined herein below). In this regard, financial information may include, but is not limited to, a transaction history, an identity of a funds transfer recipient(s), one or more account balance(s), a fraud risk, an account history (e.g., predicted withdrawals/deposits over a certain amount of time, etc.), etc. The tier is an assignment of a user into a particular category useable for determining the dynamic limit for the user (e.g., transaction specific, spending limit over a period of time, use of a payment channel, etc.). In this regard, the “tier” may be an initial starting point or input. The tier may change on a schedule in response to the user's transactions, deposits, withdrawals, use of accounts, and the like, over a specified time period. The determined tier may be displayed to the user and, in some arrangements, is re-calculated upon each use of a payment channel. Generally, individuals associated with a better “financial health” may be categorized into relatively higher tiers associated with relatively higher funds transfer limits.

As used herein, the phrase “financial health” refers to the likelihood that the user will have funds available to settle a requested funds transfer and that a given transaction is one that the user will make or will likely make (e.g., more likely than not). In this regard, the “financial health” of a user may be indicative of the user's ratio of debt to assets either at a certain point in time and/or over a certain defined period of time. The “financial health” of a user may also affect the transaction specific details, specifically related to the allowed quantity (i.e., amount) and quality (i.e., recipient) of the requested transaction. For example, if the user has more outstanding or potential debts than available assets (e.g., direct deposit flow, account balance, pending deposits) the user may have a lower financial health. Therefore, a transaction request submitted by the user that designates a “riskier” recipient or amount may be rejected by the dynamic limit circuit. In this regard, the dynamic limit circuit may utilize one or more risk factors for determining whether the financial institution would object to or likely object to processing and settling a transaction. In one embodiment, the financial health incorporates a user type (e.g., business, individual, family, etc.), the funds available to the user, the transaction history (e.g., common transactions, previous recipients, payment channels used, etc.), and a fraud factor (e.g., the likelihood of fraudulent activity with a user, holistically, or for a specific transaction).

Based on the foregoing, the dynamic limit circuit is structured to control whether a requested transaction is approved or denied. It should be understood that the term “dynamically determined limit” applies to dynamic calculation of the limit for at least one of the payment channel limit, spending limit, and transaction limit. For example, if the dynamic limit circuit is described as dynamically adjusting the payment channel limit, it will be appreciated that the dynamic limit circuit could also dynamically adjust the spending limit and/or the transaction limit. The dynamic adjustment of the various limits affects the approval or denial of a requested transaction by the user. In some embodiments, the dynamic limit circuit may generate a request to prompt the user to modify a requested transaction (i.e., the requested transaction is neither approved nor denied). When approving a transaction, the dynamic limit circuit extracts details of the requested transaction to calculate or determine a dynamic transaction-specific limit and controls what payment channel(s) are used to effectuate the transaction. When the determined dynamic transaction-specific limit is less than the requested transaction funds, the dynamic limit circuit controls the rejection of the transaction and the generation and presentment of any follow-up prompts to the user. In some arrangements, the dynamic limit circuit is loaded, provided, disposed, or otherwise stored on a secure element of the user's mobile device to provide a relatively more secure location for approving or denying requested funds transfers. As will be appreciated, the dynamic limit circuit acts as an authorization engine for all payment instruments, services, and the like, for a user.

For purposes of the embodiments described herein, the term “payment channels” refers to the channel, rail, or pathway associated with the movement of funds from a payor to a payee. In this regard, the term “payment channel” refers to the “how” of transferring funds in a transaction. In contrast, a “payment device” (e.g., credit card, check, debit card, etc.) describes the “what” that is used to initiate the funds transfer. Accordingly, examples of payment channels include, but are not limited to, an electronic wire fund transfer channel, an ACH fund transfer channel, a bill pay fund transfer channel, a check processing transfer channel, a real-time payment rail, etc. In use, each payment channel typically has a limit (e.g., a transaction or fund transfer limit). In this regard, the term “limit” as applied to the payment channel refers to a boundary for a potential transaction (e.g., funds transfer). This is distinct from a spending limit, which is associated with each particular payment device. The spending limit refers to a limit, which is typically known by a user, for a payment device (e.g., credit card, debit card, etc.), such as the user having an “X” dollar limit for their credit card. In comparison, the payment channel limit is not typically known by a user; may differ from the spending limit; and, may be applied to transactions differently. For example, a user may have spending limits for each of their payment devices, yet payment devices that use the same channel may be associated with a singular limit for that specific channel (i.e., one limit for multiple payment devices). Thus, the spending limit may be different from the payment channel limit. In comparison, the transaction limit refers to a limit specific for the completion of a single transaction. Therefore, for a funds transfer request one to three dynamic limits may be determined regarding the payment channel limit, spending limit, and/or transaction limit. For example, the user may only be able to transfer an amount of 1000 U.S.D. in any single transaction, but may have a spending limit of 10,000 U.S.D. for a month, and a payment channel limit of 15,000 U.S.D. for all transaction requests that use that payment channel. Similar to the spending limit, the transaction limit may be known to the user. It should be understood that the systems, methods, and apparatuses described and disclosed herein may be applicable with each of the payment channel limit, a spending limit, and a transaction limit. In this regard, the dynamic limit circuit may dynamically determine a payment channel limit in one embodiment, dynamically determine a spending limit in another embodiment, and dynamically determine a transaction limit in another embodiment. Further, the dynamic alteration of one limit may affect the other limit(s), for example, a dynamic increase in the spending limit may result in a related increase to the transaction limit. Thus, the systems, methods, and apparatuses of the present disclosure are intended to be widely applicable with each of the payment channel, the spending limit, and the transaction limit.

In operation, the dynamic limit circuit of the present disclosure provides technical solutions to computer-centric and payment channel-centric problems associated with conventional funds transfer systems. For example, the dynamic limit circuit, according to various embodiments, provides a more effective and efficient mechanism to the industry by providing a changing control mechanism for approving and denying funds transfer requests. These computer-centric problems exist because the current payment channel ecosystem could not exist without the use of computers and communication between the computers over a network. The dynamic limit circuit provides for embodiments that overcome the shortcoming and issues with the current payment channel and limit-setting issues of processing funds transfers. Further, the methods and systems described herein alleviate the strain on processing power and memory components currently required to manage, approve, and facilitate funds transfer requests. By calculating a tier, users may be batch processed into a limited number of categories (i.e., tiers) thereby facilitating relatively quick dynamic control until more detailed individualistic assessments are conducted and made by the dynamic limit circuit. Further, by providing a communication channel that links or groups a plurality of payment channels together, the dynamic limit circuit reduces the amount of time required to effectuate various funds transfer requests.

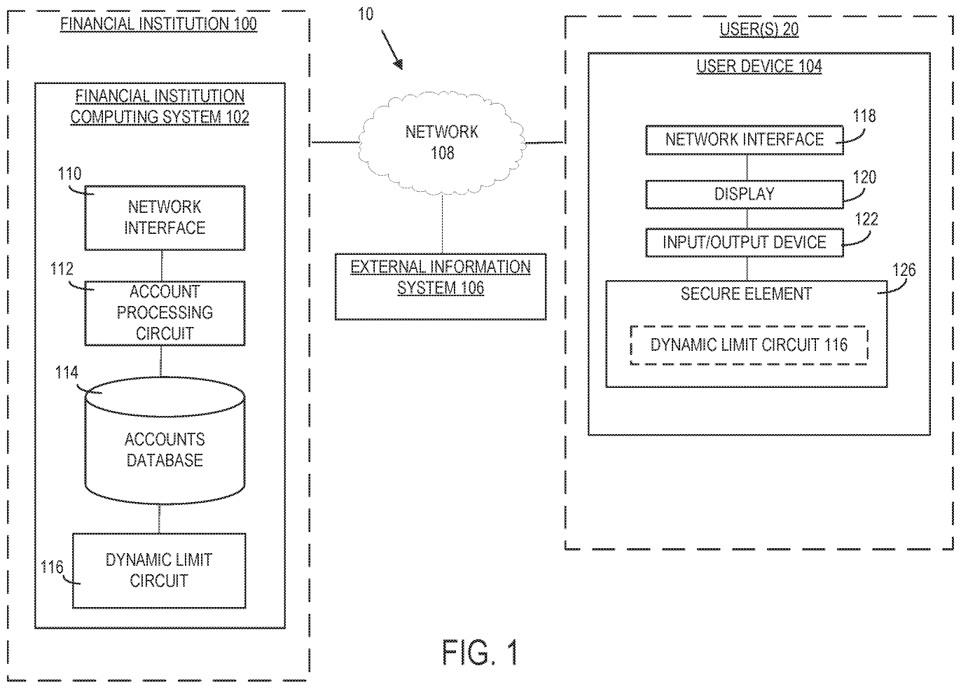

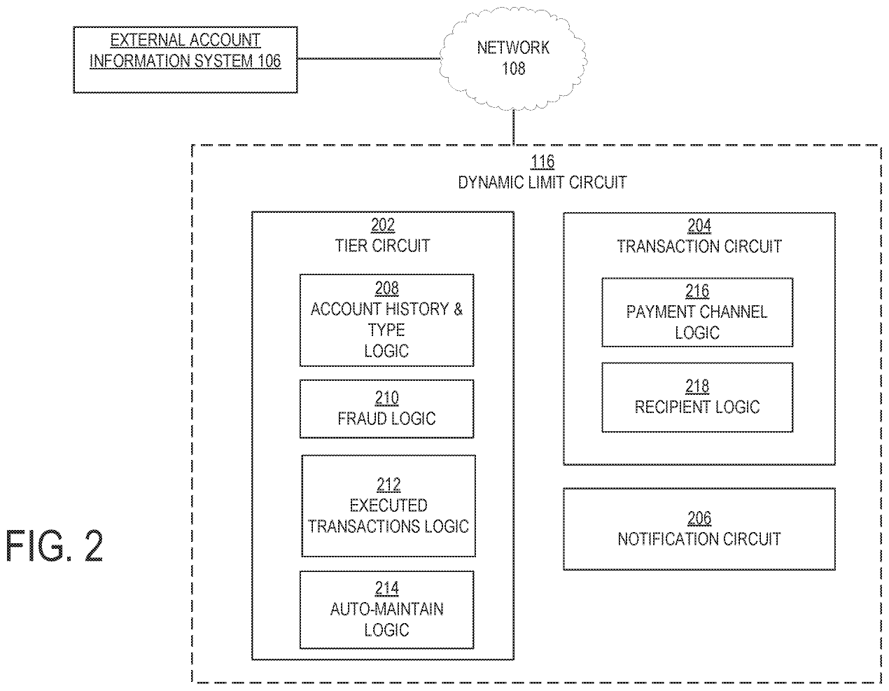

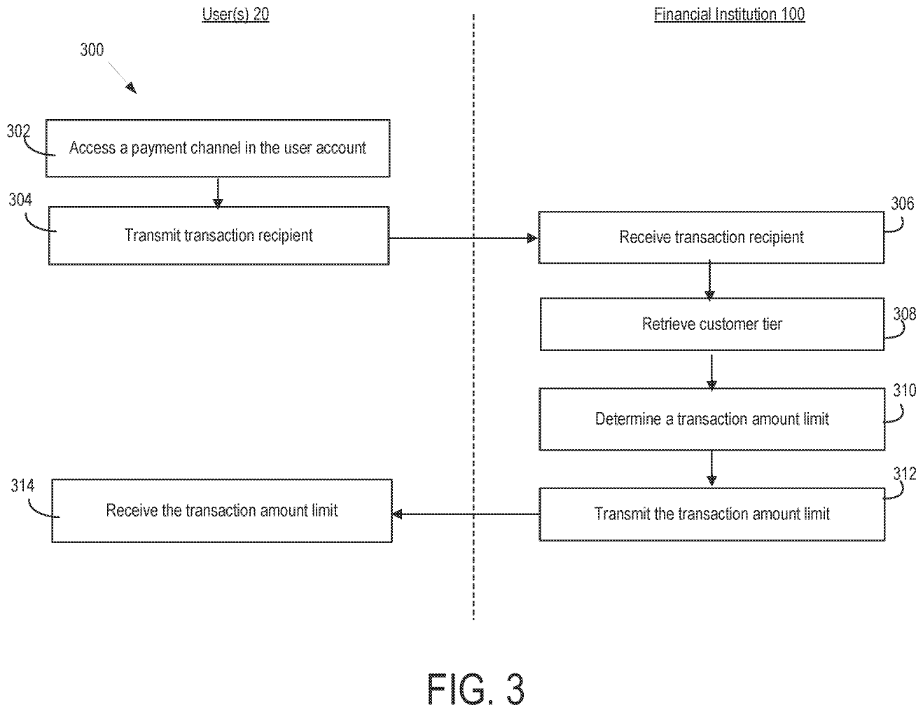

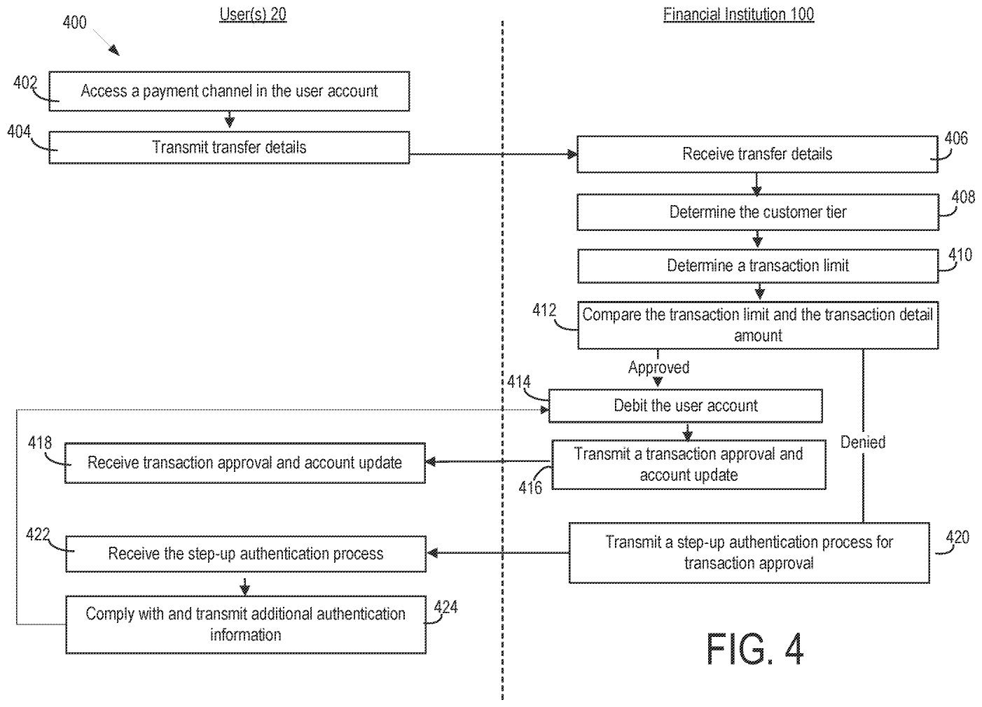

Referring now to FIG. 1, a computer-implemented funds transfer system 10 is shown, according to an example embodiment. The funds transfer system 10 includes a financial institution computing system 102 associated with a financial institution 100, a user device 104 managed by a user 20, an external account information system 106, and a network 108. The systems communicate through the network 108, which may include one or more of the Internet, cellular network, Wi-Fi, a proprietary banking network, or any other type of wired or wireless network. Each computing system 102, 104 may be structured as computer or processing system (e.g., a server with one or more processing circuits) including at least one processor or processing device and at least one memory or memory device. An example structure of the computing systems and other components of FIG. 1 and FIG. 2 are described herein below following the description of method 300 of FIG. 3 and method 400 of FIG. 4.

The user device 104 may be owned by, associated with, or otherwise operated by a user 20. In one embodiment, the user 20 is a customer of the financial institution 100 (e.g., may have an account at the financial institution 100). In other arrangements, the user 20 does not have a financial account associated with the financial institution 100 (i.e., is not a customer of the financial institution 100). As shown in the example embodiment of FIG. 1, the user 20 may be an individual user, a representative for a group of users (e.g., a company representative), or the like that has one or more accounts at the financial institution 100. The user device 104 may include any type of mobile device that may be used to monitor or is otherwise associated with the dynamic limit circuit 116. For example, the user device 104 may include, but is not limited to, a phone (e.g., smartphone, etc.), a computing device (e.g., tablet computer, laptop computer, person digital assistant, etc.), and a wearable device (e.g., smart eyeglass, a smart watch, and a smart bracelet, or other suitable device).

As shown, the user device 104 includes a network interface 118, a display device 120, an input/output device 122, and a secure element 126. The network interface 118 may include, for example, program logic and various suitable hardware components (e.g., a network chip) that connect or facilitate connection of the user device 104 to the network 108.

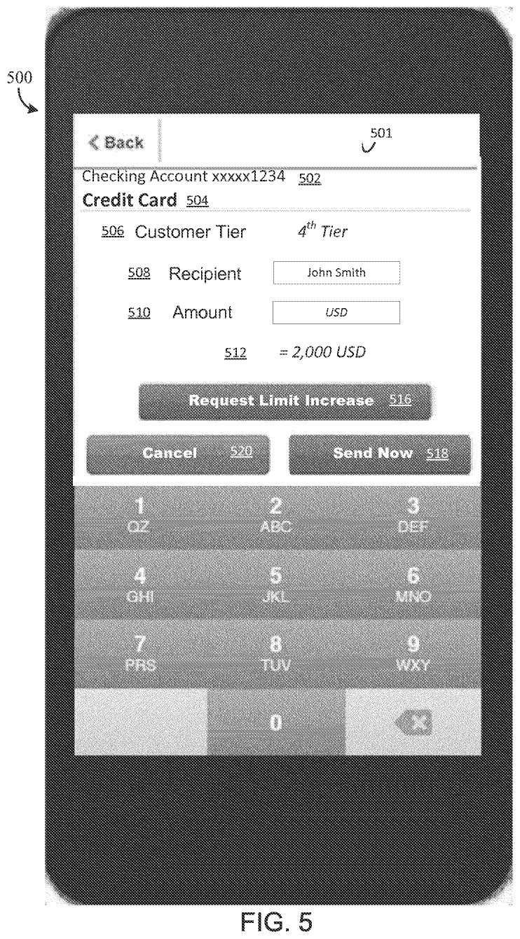

The display device 120 is structured to receive and display a graphical user interface to the user 20. The graphical user interface (GUI) may display various accounts, balances, and payment services available to the user 20. The display 120 may also include showing the user 20 his or her tier as determined by the dynamic limit circuit 116. An example GUI is described below in FIG. 5. The input/output device 122 may be used to permit the user to initiate account access and to facilitate receiving requested information from the user. The input/output device 122 may include, for example, a keypad or keyboard, a touchscreen, a microphone, or any other device that allows the user to access the funds transfer system 10.

The secure element 126 is structured to be a secure memory storage device that may implement the dynamic limit circuit 116 in one embodiment. The secure element 126 represents a dynamic environment in which application code and application data can be securely stored and administered and in which secure execution of applications occur. The element may provide delimited memory for each application. The secure element may be implemented either by a separate secure smart card chip (e.g., an embedded secure element), in the SIM/UICC (which is used by GSM mobile phone operators to authenticate subscribers on their networks and maintain personalized subscriber information and applications), or in an SD card that can be inserted in the mobile phone. In some arrangements, the secure element 126 contains some of, or all of, the dynamic limit circuit 116. In other arrangements, the secure element 126 may provide for a connection to, link to, or communications to the financial institution computing system 102, and in turn the dynamic limit circuit 116.

In operation, the user 20 can view account details on the display 120 including a tier assignment, additional authentication options, and/or passcode information. Once authorized, an interface may be provided to the user 20 that allows the user 20 to submit a transaction request, receive a dynamically determined transaction limit in response to the transaction type and/or recipient, view the tier, and other features controlled by the dynamic limit circuit 116.

The external information system 106 is structured to provide information about the user 20 to the financial institution computing system 102, regarding at least one of the user's fraud history, financial health, and history regarding one or more accounts held at other financial institutions. The external information system 106 provides financial information about the user 20 that the financial institution 100 may not have access to in order to generate a more robust and accurate financial health profile. The external information system 106 may comprise credit history report/information (e.g., by Equifax, Experian, Trans Union, etc.), outstanding loan applications, outstanding debts with other financial institutions, and the like. For example, the external account history system 106 may have user information regarding an identity theft claim with an account at a different financial institution.

As shown, the financial institution computing system 102 includes a network interface 110, an account processing circuit 112, an accounts database 114, and a dynamic limit circuit 116. In some embodiments, the dynamic limit circuit 116 is a standalone computing system in communication with the financial institution computing system 102. The network interface circuit 110 is structured to facilitate operative communication between the financial institution computing system 102, the user device 104, and the external information system 106 over the network 108.

The account processing circuit 112 is structured to track, maintain, and incorporate transaction details for an account held by the financial institution 100. The account processing circuit 112 may interact with the dynamic limit circuit 116 to ensure that when a customer or user 20 makes a request to send funds to a third-party, that the funds are debited from the proper customer account. Additionally, the account processing circuit 112 may store all or mostly all of the transaction information in an accounts storage database 114 within the financial institution computing system 102. As shown in FIG. 1, the account processing circuit 112 provides account information to the dynamic limit circuit 116 to facilitate the generation of user tier for selective approval or denial of a proposed transaction.

The accounts database 114 is structured to store information regarding accounts at the financial institution 100. The information may include, but is not limited to, an age of the user, a membership date, account numbers and type of accounts held by the customer, various statements (e.g., credit/debit statements for the accounts), passkey information, and so on for a plurality of users. Additional information may include details regarding the types of accounts held within a financial institution, the type of user (e.g., a representative for many users, a commercial entity, an individual, etc.), prior issues with fraud or other credit related information, when various payment occurred, a receiving entity for each payment, an amount of each payment, a location of the user for each payment, etc.

Based on the foregoing and using at least some of the above information, the dynamic limit circuit 116 is structured to determine an initial tier for a user 20, and to selectively control the approval of a funds transfer request based on at least one of the initial tier placement and a dynamically determined limit for the transaction request, wherein the “limit” can be at least one of a payment channel limit, a spending limit, and a transaction limit. As shown in FIG. 1, the dynamic limit circuit 116 is implemented with a financial institution computing system 102. In another embodiment and as mentioned above, the dynamic limit circuit 116 may be a dynamic limit computing system implemented separate from the financial institution computing system 102. Further explanation of the structure and activities of the dynamic limit circuit 116 are shown in FIG. 2.

Accordingly, referring now to FIG. 2, a schematic diagram of the dynamic limit circuit 116 of FIG. 1 is shown according to an example embodiment. The dynamic limit circuit 116 includes a tier circuit 202, a current transaction circuit 204, and a notification circuit 206. In some arrangements, the dynamic limit circuit 116 can be a stand-alone computing system in communication with the financial institution computing system 102. Accordingly, the dynamic limit circuit 116 may have access to account information, transaction history, account type, and account history for each user 20 at the financial institution 100 enrolled in the dynamic limit service (e.g., a service, such as a subscription service, that makes use of the dynamic limit circuit 116). Generally speaking and explained in more detail herein, the dynamic limit circuit 116 is structured to place a user 20 into a tier via the tier circuit 202, to receive a funds transfer request, and to determine a limit for the transaction request, via the transaction circuit 204. As shown in FIG. 2, the dynamic limit circuit 116 is operably connected to the external account information system 106 via the network 108.

The tier circuit 202 is structured to calculate and control placement of the user 20 into a tier. As such, the tier circuit 202 may be in operative communication with the account processing circuit 112 of the financial institution computing system 102 in FIG. 1. In particular, the tier of the user may be determined or calculated based on a variety of inputs and factors. Further and in addition to controlling placement of a user into a tier, the tier circuit 202 may control generation of a notification regarding the placement, and control subsequent adjustment of the tier in response to various activity regarding the user 20. In one arrangement, the tier circuit 202 may dynamically update the user's tier information on a scheduled basis responsive to the user's funds transfer requests and financial history over that time period. In other arrangements, the tier circuit 202 serves solely as an initial placement of the account into a tier and then the account is adjusted via the dynamic limit circuit 116. An example of a tier system used by the tier circuit 202 may be include a first tier, a second tier, and a third tier. The first tier may be associated with relatively higher limits than the second tier, which is associated with relatively higher limits than the third tier. However, and because each user may have very different existing limits (e.g., $50,000 versus $1,000), the tier circuit 202 may include additional logic that dynamically adjusts the limit based on the tier assignment. For example, the limit may be adjusted to ten percent less than the user's maximum payment channel limit in tier 1, whereas in tier 2, the limit may be adjusted to 20 percent less than the user's maximum payment channel limit. Beneficially, by utilizing a relatively small amount of tiers with various logic, the tier circuit 202 may quickly and efficiently place users into a tier and still dynamically control the user's limit relative to personal information related to the user. Based on the foregoing, example inputs that can be used to control tier placement are described below. In addition to controlling the tier assignment, the tier circuit 202 can provide the user with information regarding why the user is currently placed in the provided tier. Beneficially, having several initial tiers allows the dynamic limit circuit 116 to serve a wide and diverse variety of accounts at a single time without potentially time-consuming calculations and determinations for each user account at the outset (i.e., upon an initial enrollment with the service). Rather, the tier placement enables a user to sign up for this service and immediately reap the benefits.

As shown, the tier circuit 202 includes an account history/type logic 208, fraud logic 210, executed transactions logic 212, and auto-maintain logic 214. Each of the logics 208, 210, 210, and 214 may be structured to collect and store various pieces of information regarding the user 20 and/or one or more accounts associated with the user 20. The collected and stored information may be used by the tier circuit 202 to control placement of the user 20 into an initial tier. The inputs may provide an indication of a financial health profile of the user. The financial health profile of the user may be used, by the tier circuit 202, to determine a “risk” associated with extending a greater or lower spending limit or transaction limit for future transactions. The tier provides a starting point for determining the limit that is indicative of the user's own funds transfer history and financial profile. In some embodiments, the tier circuit 202 may draw inputs, over the network 108, from information provided by an external account information system 106 that has account information relating to other financial accounts held by the user and fraudulent activity with other financial accounts that a user may have.

The account history and type logic 208 is structured to have access to all, or mostly all, of the user 20 information and details associated with the user's 20 account, including, the account type (e.g., checking, savings, money market, etc.), the number of payment channels available to the user (this may be based on the type of account associated with the user and/or the payment devices associated with the user), one or more account balances, the length of time the user 20 has been a member of the financial institution, and other user specific factors and information. Thus, the account history and type logic 208 may be structured to acquire and assemble information regarding one or more accounts of the user 20. For example, the initial placement of the user tier with an extensive history of payments to trusted entities (e.g., the IRS, electric company, nation-wide businesses, etc.), is greater than a the initial user tier for an account with a history of cash withdrawals and payments to small companies overseas.

The user fraud logic 210 is structured to generate a user 20 fraud factor based on information associated with the user 20 and the user account, alone, or a combination of the two. The term “fraud factor” refers to the likelihood of fraudulent activity with a user, indicative of the increased risk associated with the user 20 and increased difficulty of recourse by the financial institution 100 if a fraudulent transfer were to occur. The fraud factor can be based on information regarding at least one of previous fraudulent activity information relating to an account of a user, external information from a third-party fraud prevention service, an intended recipient, a type of transaction requested, various geographic factors, and the like. For example, the information associated with the user can include criminal records, bankruptcy history and the like, whereas the user's account information may include payment history, transaction types and amount, and history of fraudulent transaction claims. In that regard, the “fraud factor” may be represented as a scale, rating, or a similar measurement/classification system. For example, in one arrangement, the fraud factor is a numerical scale of 1-10 whereby a high fraud factor (e.g., a score of 6 or higher) corresponds with the potential for fraudulent activity associated with the user being greater than a low fraud factor (e.g., a score of 5 or lower). In some arrangements, the user fraud logic 210 may be operably connected to the external account information system 106 over the network 108. The external account information system 106 may provide information regarding the user's 20 fraudulent activity for accounts held outside of the financial institution 100. For example, the user had three instances of identity theft at two other financial institutions over a five year period, resulting in a greater risk of compromise and a higher fraud factor.

The executed transaction logic 212 is structured to analyze the user's 20 prior transactions, including transaction amount, transaction type, the recipient, and the like, to generate a prior transaction history profile. The executed transaction logic 212 is operatively connected to the account processing circuit 112 or other circuits to access information regarding the previous transactions of the user. Generally, the prior transaction history profile provides an overview (e.g., snapshot, summary, etc.) of the types of payments and recipients of the payments in order to develop a financial health determination for the user 20.

In one arrangement, the tier system is only used an initial placement tool. After placement and subsequent transactions, the dynamic limit circuit determines a limit specific to the user independent of the initial tier placement. In another arrangement, the dynamic limit circuit determines the limit based on a continual tier determination. In this regard, there may be a plurality of tiers (e.g., 1-50) used by the tier circuit 202. After placement and subsequent transactions, the dynamic limit circuit can re-determine the tier for the user, resulting in a different initial determination of the dynamic limit for a user's funds transfer request. This may result in an greater tier placement, the same tier placement, or a decrease in the tier placement. In this arrangement, an auto-maintain logic 214 may be included with the tier circuit 202 to control placement. The auto-maintain logic 214 is structured to dynamically adjust the calculated tier for a user 20 on some schedule or to dynamically adjust the payment channel limit for the user based on financial activity. The auto-maintain logic 214 facilitates the determination of the account information, the user fraud, and executed transactions factors. For example, every two weeks a user's tier can be recalculated in order to better reflect each user's payment channel limit(s) for the associated payment channels. The auto-maintain logic 214 may be set to update the user account tier status whenever a request to use a user payment channel is received. Beneficially, the auto-maintain logic 214 may provide feedback to the why the user's tier has changed or remained the same.

The current transaction circuit 204 is structured to receive a funds transfer request with the financial institution 100, determine a limit, and either approve or deny the requested transaction. As shown, the current transaction circuit includes payment channel logic 216 and recipient logic 218. The current transaction circuit 204 uses the user's tier, determined by the tier circuit 202, to calculate a limit for a requested funds transfer. As will be appreciated, a greater user tier, will result in a greater limit calculated for the funds transfer request. Accordingly, the dynamically adjusted limit, which can include a payment channel limit, spending limit, and transaction limit is responsive to the user tier. In some arrangements, the tier is used only as an initial placement tool to determine the first limit, with the subsequent dynamic adjustment to the limit made in view of at least the user's funds transfer history, payment channel history, current transaction request, and previously determined limit. In other arrangements where the user tier is adjusted on a scheduled basis, a funds transfer request will result in a dynamic limit made in view of at least the user's funds transfer history, payment channel history, current transaction request, previously determined limit, and current user tier. Depending on the implementation, the current transaction circuit 204 may use anywhere from one or both the payment channel logic 216 and the recipient logic 218. For example, if the dynamic limit circuit 116 is providing real-time feedback of a transaction limit for a entered recipient, as shown in method 300 of FIG. 3, only the recipient logic 218 may be used. If the calculated transaction limit is greater than the received requested transaction amount, then the current transaction circuit 204 may approve the transaction. Conversely, if the calculated limit is less than the received requested transaction amount, then the current transaction circuit 204 may reject the transaction. As mentioned above, the current transaction circuit 204 is shown to include payment channel logic 216 and recipient logic 218.

Referring first to the payment channel logic 216, the payment channel logic 216 is structured to determine what specific payment channel is being requested. To make such a determination, the payment channel logic 216 may receive various factors set by the financial institution for specific types of transactions. For example, the payment channel logic 216 may receive a transaction request to send one million U.S.D. through a bill pay mechanism, however the financial institution may have set a max bill pay transaction limit of two hundred thousand U.S.D. Thus, the payment channel logic 216 may determine that the bill pay mechanism is inappropriate for this request and select a different payment channel.

The transaction recipient logic 218 is structured to receive a designated entity and/or account for the requested transaction. The type of recipient may cause an increase, decrease, or have no effect on the resulting limit determined by the transaction circuit 204. The transaction recipient logic 218 may be in communication with the fraud logic 210 to provide further accuracy in determine the fraud factor for the specific transaction in view of the transaction recipient. For example, a bill pay to the power company may slightly increase the limit, whereas a wire-to-wire transfer to an overseas account my decrease the limit. In some embodiments, the current transaction circuit 204 is structured to process a payment channel request from the user for a specific recipient before the user enters in an amount, in other words, it provides the limit to the transaction before the user enters in a value, as described below in method 300 of FIG. 3.

The notification circuit 206 is structured to transmit and manage notifications that are provided to users 20 as a result of the processes and determinations by the dynamic limit circuit 116. For example, the notification circuit 206 may provide notifications (e.g., push notifications, SMS messages, etc.) to the client device 104 of the user 20. The particular content and triggering parameters of the notifications may be user-defined and/or may be automatically defined (e.g., by the financial institution computing system 102 that provides the dynamic limit circuit 116). Notification content may include, among other things, rejected requests, a transaction limit amount for an intended recipient, spending limits for the user over a time period, account balances, tier increases or decreases, warnings, messages, etc. Notifications may be provided in real-time or near real-time. For example, notifications may be triggered based on executed transactions, such as a payment channel limit being close to being exceeded by an executed transactions or being within a threshold value of being exceeded for a specified time frame. For example, a notification regarding a monthly limit (payment channel?) on the amount of transactions for a specific payment channel with a user's 20 account. Further, the notification circuit 206 may be set to automatically generate upon a certain condition occurring. For example, if a risky or suspicious payment channel is requested, the dynamics limit circuit may require the user to authenticate at a brick and mortar banking institution in order to allow for further account transactions and activity.

By way of example, the dynamic limit circuit 116 may place the user in a third tier, based on factors of the risk rating of the user (e.g., likelihood of fraudulent payments or identity theft, etc.), behavioral scores (e.g., the user's spending pattern, frequent merchants, payment locations, overdraft occurrences, etc.), and account balances. The third tier is associated with a moderate starting point (for example, 1000 U.S.D.) for the limit determined by the dynamic limit circuit 116. At some point a requested transaction, including a recipient, speed of delivery, and other details is received. The dynamic limit circuit 116 will use the tier status of the user to determine the limit for the transaction. The determined limit may be greater depending on the transaction details. For example, if the transaction request is a four-day delayed payment to another user of the financial institution (e.g., such that there is a high recourse likelihood) the dynamic limit circuit 116 outputs a limit for the transaction of 5,000 U.S.D. Alternatively, if the transaction request is an immediate payment to an account out of the country, never before engaged with the user in a payment, with a beneficiary bank being in that foreign country (e.g., little to no recourse likelihood) the dynamic limit circuit 116 outputs a limit for the transaction of 500 U.S.D. In this use, the apparatus adjusts the dynamic limit in response to the user and the risk associated with the transaction.

By way of example, the dynamic limit circuit 116 may place the user in a first tier, based on factors of the risk rating of the user (e.g., likelihood of fraudulent payments or identity theft, etc.), behavioral scores (e.g., the user's spending pattern, frequent merchants, payment locations, overdraft occurrences, etc.), and very high account balances. The first tier is associated with a higher starting point (for example, 10,000 U.S.D.). At some point a requested transaction, including a recipient, speed of delivery, and other details is received. The dynamic limit circuit 116 will use the tier status of the user to determine the limit for the transaction. The determined limit may be greater depending on the transaction details. The dynamic limit circuit 116 is responsive to recent financial activity of the user. For example, the user has an account balance of 50,000 U.S.D., recurring monthly bill payments of 5,000 U.S.D. and makes a first payment request of 10,000 U.S.D. to the IRS (e.g., a trusted and known beneficiary to the financial institution). The dynamic limit circuit 116 approves the first transaction. On the same day, the user makes a second payment request of 8,000 U.S.D. to a beneficiary at another financial institution but within the same country as the user. The dynamic limit circuit 116 would determine a lower limit for the transaction due to the recent financial activity of the user and the upcoming recurring bill payments. Additionally, the dynamic limit circuit 116 may request additional authentication from the user before the dynamic limit circuit 116 approves the transaction. Alternatively, the dynamic limit circuit 116 may require the user to replenish funds into an account before approving the second payment request.

Referring to FIG. 3, a flow diagram of a method 300 of determining a limit by the dynamic limit circuit 116 for a funds transfer request is shown, according to an example embodiment. The method 300 could be used to dynamically determine a payment channel limit, spending limit, and/or transaction limit for the user, which may result in the approval or denial of a single requested transaction. Further, the method 300 may be implemented, at least in part, by the dynamic limit circuit 116 and the components of FIGS. 1-2, such that reference may be made to the components of FIGS. 1-2 to explain method 300.

Method 300 begins with the presumption that the user 20 has been placed into a tier by the dynamic limit circuit 116. In this arrangement, the user 20 is providing a transaction recipient and the dynamic limit circuit 116 generates a limit responsive to the user's tier and the transaction recipient. At 302, the user 20 accesses a payment channel associated with a payment device and initiates a funds transfer request for the payment channel through the payment device.

At 304, a transaction recipient for a funds transfer request is transmitted by the user 20 through the payment device to the financial institution 100. The funds transfer request may include information relating to the intended recipient for the requested funds transfer (e.g. transaction), a source account for the funds transfer, and any other information relating to a funds transfer request (e.g., a speed of the funds transfer, etc.). For example, the user may designate a bill pay recipient as the City Power Company to be transferred that day from the user's 20 savings account. At 306, the financial institution 100 receives the transaction recipient from the user device 104.

At 308, the financial institution computing system 102 retrieves the previously assigned tier of the user 20. The user's tier is the initial value of the user 20 used in determining the limit for a funds transfer request. As explained in greater detail above, the user's tier is based on a plurality of inputs regarding the user's 20 account history, previous funds transfers, a fraud factor, financial health, and the like. In some arrangements, the user tier may have privileges associated with the tier status that affect the limit. For example, the user may be in a high tier “3” which has an associated privilege that the limit for a single funds transfer request can be equal to the total available funds in the account and a funds transfer request of that size will be cleared within 48 hours. Alternatively, the user may be in lower tier “8”, which only allows the limit for a single funds transfer request to be no greater than 20% of the available funds in an account for any transaction that needs to be cleared in 24 hours.

At 310, the dynamic limit circuit 116 dynamically determines the limit for the funds transfer request responsive to the user's 20 intended recipient. As will be appreciated, the dynamically determined limit is responsive the user's previous transaction history, account tendencies, available funds, sources of income (e.g., regular deposits into an account), sources of debt (e.g., mortgage, monthly bill pay, etc.), financial institution's recourse given the transaction details, and the like. In some arrangements, the dynamic limit circuit 116 may dynamically adjust the payment channel limit, which in turn could affect the spending limit and transaction limit of the user. For example, the user 20 requests a bill pay recipient as the City Power Company and the dynamic limit circuit 116 determines a limit responsive to the “trustworthy” (e.g., established payee with a history of transactions) recipient that increases the payment channel limit for the user from the payment channel's previous limit, and in turn increases the transaction limit tied to the payment device. In other arrangements, the dynamic limit circuit 116 may only determine a limit that is specifically tailored to be a transaction specific limit. For example, the user 20 requests a bill pay recipient as the City Power Company and the dynamic limit circuit 116 only determines the limit for a single transaction to the City Power Company given the user's tier status and funds available in the identified source account.

At 312, the determined limit is transmitted from the financial institution computing system 102 to the user device 104. The limit may be transmitted in a pop-up notification on the user device, in a “limit” term field on the user device, or similar display mechanism.

At 314, the user 20 receives the transaction limit for a transaction with the intended recipient. The user receives the limit in real-time, in other words, when the user enters the recipient into the financial institution 100 interface, the dynamic limit circuit 116 calculates the limit and displays the transaction limit on the user 20 device. An example GUI is described below in FIG. 5. In some embodiments, the user 20 may receive instructions or additional steps that can be taken to increase the calculated limit. For example, a step-up authentication message. The step-up authentication steps may include, for example, adding funds to the source account, traveling to a branch of the financial institution 100 to provide identification, providing further details regarding the recipient, and the like. The step-up authentication can include a splash page when the user accesses a website associated with the financial institution, a push notification, a text message, and an email message to the user.

Referring to FIG. 4, a flow diagram of a method 400 of approval by the dynamic limit circuit 116 of a funds transfer request which includes an intended transaction recipient and amount is shown, according to an example embodiment. The method 400 could be used to dynamically determine a payment channel limit, spending limit, and/or transaction limit for the user, which may result in the approval or denial of a single requested transaction. Further, the method 400 may be implemented, at least in part, by the dynamic limit circuit 116 and the components of FIGS. 1-2, such that reference may be made to the components of FIGS. 1-2 to explain method 400.

Method 400 begins with the presumption that the user 20 has been placed into a tier by the dynamic limit circuit 116. In this arrangement, the user 20 is providing a transaction recipient and the dynamic limit circuit 116 generates a limit responsive to the user's tier and the transaction recipient. At 402, the user 20 accesses a payment channel associated with a payment device and initiates a funds transfer request for the payment channel through the payment device. This access occurs on the user device 104 and provides authentication to the financial institution computing system 102 to access the services offered by the financial institution 100. This step may include a mutual authentication process between the user 20 and the financial institution 100. In some embodiments, prior to the user 20 accessing the payment channel, the financial institution computing system 102 determines that the user is enrolled in the dynamic limit service. Once authenticated, the user 20 is able to access the payment channels tied to the account.

At 404, the user 20 enters the details for the requested funds transfer (e.g. transaction), including the desired payment channel (e.g., bill pay, credit card, etc.), the transfer amount, source account, the transfer recipient, and any other details relating to the funds transfer request (e.g., a speed of the funds transfer, etc.). For example, the user may submit a bill pay recipient of the City Power Company, for 50 U.S.D. to be transferred from the user's 20 savings account.

At 406, the financial institution 100 receives the transfer details. The transfer details are received on the financial institution computing system 102 from the user device 104 that has been authenticated and has access the payment channels tied to the account. At 408, the financial institution computing system 102 determines the tier of the user 20. As discussed above, the user's tier is the initial value in determining the limit for a given requested transaction.

At 410, the dynamic limit circuit 116 dynamically adjusts the payment channel limit for a transfer funds request of the payment channel type and the transfer recipient given the user's 20 tier and other details. The dynamic limit circuit 116 dynamically determines the transaction limit for a transfer of funds to the user's 20 intended recipient. In other words, once the context for the transaction is collected or entered, the dynamic limit circuit 116 outputs the limit. In some arrangements, the dynamic limit circuit 116 may dynamically adjust the payment channel limit which in turn alters the transaction limit. The transaction limit is based on the user's tier and the details of the transaction recipient. The relevant details of transaction recipient includes, for example, the trustworthiness of the recipient, the type of recipient, the transaction history between the recipient and the user 20, and the like.

At 412, the financial institution computing system 102 compares the dynamic limit circuit 116 calculated transaction limit to the requested transaction amount, determined in method step 404. The dynamic limit circuit 116 will approve the transfer funds request if the dynamically determined transaction limit is greater than the requested limit, at 414. The dynamic limit circuit 116 will deny the transfer funds request if the calculated limit is less than the requested limit, at 420. In some embodiments, a denied transaction results in the financial institution computing system 102 transmitting the dynamically determined transaction limit to the user device 104. In this way, the dynamic limit circuit acts as an dynamic authorization engine for all payment instruments, services, and other payments for the user.

Turning to a denied transaction process, at 420, the financial institution computing system 102 will, if applicable, transmit to the user device 104 a set of step-up authentication steps. The authentication steps are actions, taken by the user 20, to increase the transaction limit and/or the user's tier, potentially resulting in the transfer request to be granted. The step-up authentication steps may include, for example, adding funds to the source account, traveling to a branch of the financial institution 100 to provide identification, providing further details regarding the recipient, and the like. The step-up authentication can include a splash page when the user accesses a website associated with the financial institution, a push notification, a text message, and an email message to the user.

At 422, the user 20 receives the step-up authentication process details and/or options. The user 20 complies with one of more of these options to provide additional authentication or funds to the user's accounts, at 424. The act of complying with the details may include transmitting details via the user device 104 to the financial institution computing system 102 via the network.

At 414, the user's transfer funds transaction request is approved. This is either due to the initial request, at 404, being approved by the dynamic limit circuit 116, or the user 20 has done additional actions to increase the limit, at 424. When the transaction is approved, the user's 20 account is debited by the approved transfer amount. At 416, a transaction approval message and an account update are generated by the financial institution computing system 102 and transmitted to the user 20.

At 418, the user 20 receives the transaction approval and account update on the user device 104. The user 20 may receive the confirmation and details the next time he or she logs into his or her account, or it may be retrieved instantaneously through push notifications tied to the financial institution 100.

FIG. 5 illustrates a transaction request page 501 of the GUI 500, according to an embodiment. The GUI 500 includes a mobile banking interface that may be displayed to the customer after accessing a client application through the secure element 126 on the user device 104. Generally, the GUI 500 enables the user to observe payment channel limits, changes to the payment channel limits based on user activity, the financial health of the user, submit transaction requests that are selectively approved by the dynamic limit circuit. In another embodiment, the GUI 500 may similarly be accessed via an online banking website. Upon accessing the GUI 500, the user is prompted to provide login credentials to gain access to the account with the financial institution. By providing such credentials, the user may be provided with the full functionality of the online banking system.

The GUI 500 may display the current account information 502 as well as the payment channel type 504 through which the transaction request is being generated. In some embodiments, the user's tier value 506, determined by the tier circuit 202 in FIG. 2, is displayed. The GUI 500 enables the user to observe their payment channel limit 512 and tier 506 change based on their financial activity. The user's tier value 506 provides the user with some information regarding their account, for example if the tier gets worse over time, the user can inquire into what activities or other account features are causing the decrease. In some arrangements the user 20 is able to click on the user's tier value 506 and an information pop-up will be generated, detailing why the user is in the user's tier and what the tier represents.

The recipient field 508 defines the identifier or address of the recipient 508 to which funds will be sent. This could be, for example, an email address or phone number of the third-party recipient. When the user enters in the recipient, the dynamic limit circuit 116 determines the payment channel limit 512 for a transaction of that type and using that payment channel. For example, as shown in FIG. 5, the payment channel of Bill Pay for the user's checking account, to the recipient “John Smith” results in a real-time display of the payment channel limit 512 for that transaction, of twenty thousand U.S.D. The amount field 510 defines the amount of funds the customer would like to transmit to the third-party recipient. In some embodiments, the user cannot enter a value in the amount field 510 greater than the payment channel limit 512. In other arrangements, the amount field 510 has no limit, however, if it is greater than the payment channel limit 512 the transaction will be rejected.

If the user would like to increase the value of the payment channel limit 512, the user may select the “Request Limit Increase” button 516 to attempt to increase the limit by performing additional steps. These additional steps may be determined by the tier circuit 202 in FIG. 2. The limit increase could require the user to provide additional authentication information in order to increase the tier of the account or to deposit more funds into an account. Other authentication options can include, but are not limited to, providing biometric information through the input device 122 on the user device 104 and traveling to a brick and mortar financial institution to provide authentication in the form of biometrics or additional identifying information. The user may choose to approve the transaction displayed by selecting the “Send Now” button 518, or the user may cancel the transaction request via the “Cancel” button 520. In some embodiments, either selection may lead to an additional confirmation prompt.

As shown in FIG. 5, the GUI 500 can be used to facilitate a credit card payment using the user's mobile device. For example, the user may initiate a transaction using the mobile device that contains the payment information for a credit card issued by the financial institution 102 associated with the dynamic limit circuit 116. Prior to initiating the transaction the user is placed in a tier 506 by the dynamic limit circuit 116. In this arrangement, the dynamic limit circuit 116 generates two limits, first a dynamic spending limit for a specified time period and then a related transaction limit for the actual transaction 512. The spending limit is a holistic limit for all transactions over a time period, the spending limit is dynamically adjusted according to the user's financial activity for all payment devices and payment channels. On the front-end, the user will enter the recipient details for the a desired transaction. On the back-end the dynamic limit circuit 116 calculates and displays a dynamically adjusted transaction limit 512. In some arrangements, the dynamically adjusted spending limit affects the adjustment of the dynamically calculated transaction limit. Additionally, the completed transaction may alter the dynamically adjusted limit for the associated payment channel.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations may depend on the machine-readable media and hardware systems chosen and on designer choice. It is understood that all such variations are within the scope of the disclosure. Likewise, mobile applications and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A computer-implemented method, comprising:
providing an authorization engine for a plurality of payment instruments of a user to a mobile device associated with the user, comprising:
storing computer-executable instructions embodying a dynamic limit circuit on a secure element of the mobile device, the secure element comprising at least one of a secure smart card chip, a universal integrated circuit card, a subscriber identification module card, or a secure digital memory card;
loading the computer-executable instructions into a memory of the mobile device; and
communicatively coupling the dynamic limit circuit to a financial institution computing system associated with a financial institution;
pulling, by the mobile device via the dynamic limit circuit, from the financial institution computing system, information of the user including at least one of a plurality of payment channels associated with the user, an associated payment device of the user, a user account type, a user account balance, a user type, a user account history, a user fraud factor, a length of account time, or an external financial institution rating;
determining, by the mobile device via the dynamic limit circuit, a financial health of the user based on the pulled information of the user;
placing, by the mobile device via the dynamic limit circuit, the user into an initial tier of a finite number of tiers based on the financial health of the user;
determining, by the mobile device via the dynamic limit circuit, a limit for the user based on the initial tier placement of the user;
adjusting, by the financial institution computing system, the limit for the user based on a funds transfer request on one or more of the plurality of payment channels through the associated payment device, wherein the adjusted limit is responsive to the funds transfer request and the initial tier placement of the user;
rejecting, by the financial institution computing system, the funds transfer request based on the adjusted limit;
generating, by the mobile device via the dynamic limit circuit, an authentication request with a failed transaction message; and
rendering, by the mobile device via the dynamic limit circuit, the authentication request as a splash page when the user accesses a website associated with the financial institution, the splash page indicating an additional step for the user to complete to obtain an approval, wherein the additional step comprises:
receiving biometric information from the user;
authenticating the biometric information received from the user;
increasing, responsive to authenticating the biometric information received from the user, the adjusted limit;
approving, by the financial institution computing system, the funds transfer request based on the increased adjusted limit; and
updating, by the mobile device via the dynamic limit circuit in real-time, a graphical user interface displayable on the mobile device associated with the user that provides an indication of how a request to use the one or more of the plurality of payment channels affects a tier value of the user relative to the initial tier placement.

2. The method of claim 1, further comprising:
receiving, by the mobile device via the dynamic limit circuit, a user input to the graphical user interface, the user input comprising a selection of a graphical representation of the tier value of the user;
generating, responsive to receiving the user input, a pop-up notification comprising a custom report explaining the tier value of the user; and
rendering, by the mobile device via the dynamic limit circuit, the pop-up notification.

3. The method of claim 1, further comprising:
cyclically pulling, by the mobile device via the dynamic limit circuit, from the financial institution computing system, updated information of the user at a predetermined number of intervals;
modifying, by the mobile device via the dynamic limit circuit, the financial health of the user based on the updated information of the user; and
placing, by the mobile device via the dynamic limit circuit, the user into an updated tier of the finite number of tiers based on the modified financial health of the user.

4. The method of claim 1, further comprising:
generating, by the mobile device via the dynamic limit circuit, a confirmation of the approval of the funds transfer request based on the increased adjusted limit; and
rendering, by the mobile device via the dynamic limit circuit, the confirmation to the user when the user logs into an account associated with the financial institution.

5. The method of claim 1, wherein the limit is a spending limit, the spending limit being associated with the payment device of the user, and wherein the spending limit is different than the payment channel limit.

6. The method of claim 1, wherein the limit is a payment channel limit, the payment channel limit being a maximum funds transfer amount for the payment channel.

7. The method of claim 1, wherein the additional step includes instructing, by the financial institution computing system, the user to travel to a branch of the financial institution to authenticate.

8. The method of claim 1, further comprising:
receiving, by the financial institution computing system, a transaction recipient with the funds transfer request;
dynamically adjusting, by the financial institution computing system, the limit for the user based on the funds transfer request, wherein the new limit is a transaction specific limit; and
transmitting, by the financial institution computing system to a user device, the transaction specific limit.

9. A computing system comprising:
an accounts database structured to store information regarding a user; and
a dynamic limit circuit stored on a secure element of a mobile device associated with the user, the secure element comprising at least one of a secure smart card chip, a universal integrated circuit card, a subscriber identification module card, and a secure digital memory card communicably and operatively coupled to the accounts database, the dynamic limit circuit structured to:
provide an authorization engine for a plurality of payment instruments of the user to the mobile device;
pull the information regarding the user from the accounts database, the information of the user including at least one of a plurality of payment channels associated with the user, an associated payment device of the user, a user account type, a user account balance, a user type, a user account history, a user fraud factor, a length of account time, or an external financial institution rating;
determine a financial health of the user based on the pulled information of the user;
place the user into an initial tier of a finite number of tiers based on the financial health of the user;
determine a limit for the user based on the initial tier placement of the user;
adjust the limit for the user based on a funds transfer request on one or more of the plurality of payment channels through the associated payment device, wherein the adjusted limit is responsive to the funds transfer request and the initial tier placement of the user;
reject the funds transfer request based on the adjusted limit;
generate an authentication request with a failed transaction message; and
render the authentication request as a splash page on the mobile device of the user when the user accesses a website associated with a financial institution associated with the system, the splash page indicating an additional step for the user to complete to obtain an approval, wherein the additional step comprises:
receiving biometric information from the user;
authenticating the biometric information received from the user;
increasing, responsive to authenticating the biometric information received from the user, the adjusted limit;
approving the funds transfer request based on the increased adjusted limit; and
updating a graphical user interface displayable on the mobile device associated with the user that provides an indication of how a request to use the one or more of the plurality of payment channels affects a tier value of the user relative to the initial tier placement.

10. The system of claim 9, wherein the dynamic limit circuit is further structured to:
receive a user input to the graphical user interface, the user input comprising a selection of a graphical representation of the tier value of the user;
generate, responsive to receiving the user input, a pop-up notification comprising a custom report explaining the tier value of the user; and
render the pop-up notification on the mobile device of the user.

11. The system of claim 9, wherein the dynamic limit circuit is further structured to:
cyclically pull, from the accounts database, updated information of the user at a predetermined number of intervals;
modify the financial health of the user based on the updated information of the user; and
place the user into an updated tier of the finite number of tiers based on the modified financial health of the user.

12. The system of claim 9, wherein the dynamic limit circuit is further structured to:
generate a confirmation of the approval of the funds transfer request based on the increased adjusted limit; and
render the confirmation to the user on the mobile device when the user logs into an account associated with the financial institution.

13. The system of claim 9, wherein the limit is a payment channel limit, the payment channel limit being a maximum funds transfer amount for the payment channel.

14. The system of claim 9, wherein the limit is a spending limit, the spending limit being associated with the payment device of the user, and wherein the spending limit is different than the payment channel limit.

15. The system of claim 9, wherein the dynamic limit circuit is further structured to instruct the user to travel to a branch of the financial institution to authenticate.

16. The system of claim 9, wherein the dynamic limit circuit is further structured to:
receive a transaction recipient with the funds transfer request;
dynamically adjust the limit for the user based on the funds transfer request, wherein the new limit is a transaction specific limit; and
transmit the transaction specific limit.

17. A non-transitory computer-readable media having computer-executable instructions embodied therein that, when executed by a dynamic limit circuit of a financial institution computing system stored on a secure element of a mobile device associated with a user, causes the dynamic limit circuit to perform operations, the operations comprising:
providing an authorization engine for a plurality of payment instruments of the user to the mobile device associated with the user;
pulling, from an accounts database of the financial institution computing system associated with a financial institution, information of the user including at least one of a plurality of payment channels associated with the user, an associated payment device of the user, a user account type, a user account balance, a user type, a user account history, a user fraud factor, a length of account time, or an external financial institution rating;
determining a financial health of the user based on the pulled information of the user;
placing the user into an initial tier of a finite number of tiers based on the financial health of the user;
determining a limit for the user based on the initial tier placement of the user;
adjusting the limit for the user based on a funds transfer request on one or more of the plurality of payment channels through the associated payment device, wherein the adjusted limit is responsive to the funds transfer request and the initial tier placement of the user;
rejecting the funds transfer request based on the adjusted limit;
generating an authentication request with a failed transaction message; and
rendering the authentication request as a splash page on the mobile device when the user accesses a website associated with the financial institution, the splash page indicating an additional step for the user to complete to obtain an approval, wherein the additional step comprises:
receiving biometric information from the user;
authenticating the biometric information received from the user;
increasing, responsive to authenticating the biometric information received from the user, the adjusted limit;
approving the funds transfer request based on the increased adjusted limit; and
updating a graphical user interface displayable on the mobile device associated with the user that provides an indication of how a request to use the one or more of the plurality of payment channels affects a tier value of the user relative to the initial tier placement.

18. The non-transitory computer-readable media of claim 17, wherein the operations further comprise:
receiving a user input to the graphical user interface, the user input comprising a selection of a graphical representation of the tier value of the user;
generating, responsive to receiving the user input, a pop-up notification comprising a custom report explaining the tier value of the user; and
rendering the pop-up notification on the mobile device of the user.

19. The non-transitory computer-readable media of claim 17, wherein the operations further comprise:
cyclically pulling, from the accounts database, updated information of the user at a predetermined number of intervals;
modifying the financial health of the user based on the updated information of the user; and
placing the user into an updated tier of the finite number of tiers based on the modified financial health of the user.

20. The non-transitory computer-readable media of claim 17, wherein the operations further comprise:
generating a confirmation of the approval of the funds transfer request based on the increased adjusted limit; and
rendering the confirmation to the user on the mobile device when the user logs into an account associated with the financial institution.
